(19) United States
(12) Patent Application Publication
(10) Pub. No.: US 2013/0177679 A1
(43) Pub. Date: Jul. 11, 2013

(54) Method for Adjusting a Water Temperature and a Pasteurization Tunnel

(71) Applicant: Sander Hansen A/S, Brondby (DK)

(72) Inventors: Lars Hendrik Hansen, Roskilde (DK); Lars Smith Jkergaard, Kopenhagen (DK); Jorgen Tage Nielsen, Alsgarde (DK)

(73) Assignee: Sander Hansen A/S, Brondby (DK)

(21) Appl. No.: 13/782,967

(22) Filed: Mar. 1, 2013

Related U.S. Application Data
(63) Continuation-in-part of application No. 12/065,397, filed on Jul. 3, 2008.

(30) Foreign Application Priority Data
Sep. 8, 2005 (DE) 10 2005 042 783.9

(51) Int. Cl. A23L 3/00

(52) U.S. Cl. CPC A23L 3/003
USPC 426/232; 99/483

(57) ABSTRACT

A method for adjusting or controlling the temperature of water released for product pasteurization, by taking into consideration the heat transfer into the products for the control of the water temperature. Further, a method for adjusting or controlling the water temperature for the water released for product pasteurization in several superimposed decks, by taking into consideration the water temperature in at least one deck located below the upper deck for the control of the water temperature. Also, corresponding pasteurization tunnels as well as a pasteurization tunnel with at least three superimposed decks, where the water for at least three decks is released to the products in the uppermost deck.

### CROSS REFERENCE TO RELATED APPLICATIONS

The present application is a continuation-in-part of U.S. patent application No. 12/065,397, filed Jul. 3, 2008, which claims the benefit of priority of International Patent Application No. PCT/EP2006/006073, filed on Jun. 23, 2006, which application claims priority of German Patent Application No. 10 2005 042 783.9, filed Sep. 8, 2005, the respective disclosures of which are each incorporated herein by reference in their entireties.

### FIELD OF THE DISCLOSURE

The disclosure relates to a method for controlling the temperature of water released for product pasteurization as well as to a pasteurization tunnel, e.g. the common or individual velocity of the independent decks.

### BACKGROUND

Pasteurization tunnels by means of which products, such as for example bottles, cans or other containers can be pasteurized, are known. For this, the products are transported through the pasteurization tunnel and in the process contacted with water at a predetermined temperature, so that the products are heated and possibly also cooled again. For suited pasteurization, it is important for the products to comprise a sufficiently high temperature for a sufficiently long period to achieve good sterilization. To this end, in various zones of a pasteurization tunnel, various temperatures are adjusted with which the temperature of the products can be slowly increased and possibly subsequently slowly reduced again.

In the process, it is however also important to avoid excessive pasteurization so as not to excessively influence for example the taste of drinks or other food. It is therefore necessary for a suited pasteurization operation to purposefully adjust or control the temperature of the water released for pasteurization.

Furthermore, pasteurization tunnels are known in which products are not only passed through the tunnel in one level but in two levels (decks). It is thus for example possible to transport products on two decks, and water is only put onto the upper deck and then reaches the lower deck. At a sufficiently high flow of water, the temperature difference in the upper and the lower decks is relatively small, so that with good pasteurization of the products on the upper deck, good pasteurization of the products on the lower deck can also be expected. Typically, in case of two or more decks, the velocities of the individual decks are the same.

A device and a method where water temperature is adjusted or controlled are known, for example, from the DE 103 10 047 A1.

### SUMMARY OF THE DISCLOSURE

It is the object of the present disclosure to provide a method and a pasteurization tunnel which permit an adjustment of the water temperature as optimal as possible for an optimal pasteurization result.

It is furthermore an object of the present disclosure to provide a pasteurization tunnel which has a high capacity and can have a relatively space-saving embodiment, respectively.

It is furthermore the objective of the present disclosure to provide a method for controlling the individual velocities of different superimposed decks of a pasteurization tunnel separately so as to optimize the pasteurization of the products.

In the method of controlling the water temperature, the heat transfer from the water into the products is taken into consideration. Such a control for example permits to take into consideration the cooling of the water during the contact with the products. This permits more accurate adjustments of the desired temperature of the water, so that controlled pasteurization of the products is permitted.

In an advantageous embodiment, the heat transfer into the products is taken into consideration, where the product temperature and water temperature in the corresponding products is considered. Furthermore, the feeding with products can be advantageously taken into consideration, i.e. the number, the weight or the like per time or any other quantity of products to be pasteurized.

In an advantageous embodiment, at least two, three or more decks are located one upon the other, and products for pasteurization are transported in the two decks. The water that leaves the upper deck is here used for pasteurizing the products in the deck below. The temperature of the water entering the lower deck will be determined taking into consideration the heat transfer in the deck located above.

In an advantageous embodiment, the temperature of the products is calculated from the heat transfer into the products.

A desired control value can be calculated for water temperature control in a suited manner from the calculated temperature of the products as the temperature of the products determines the pasteurization process. For each deck of the various superimposed decks, a desired control value can be calculated. From this plurality of desired control values, an individual control value can be determined which is used for the control. Here, various methods can be used to determine the control value to be used from the several desired control values. This can be, for example, the selection of a minimum value, a maximum value or that of an average value or a median or the like.

Advantageously, several control loops are provided which take into consideration several criteria. Thus, for example an additional control loop can be provided which concerns the observation of a temperature range above a minimum temperature and/or below a maximum temperature.

A method for controlling the water temperature is in particular advantageous if the control of the water temperature is performed in several successively arranged zones. The adjustment of the water temperature in the various zones, however, can interact, for example by exchanging parameters. It is thus possible, for example, that the temperature of the products resulting from the calculation in one zone is taken as input quantity for the control in an adjacent zone, for example the downstream zone.

For a method for controlling the water temperature of the water released for product pasteurization in several superimposed decks, it is provided to take into consideration the water temperature in at least one of the decks located below the upper deck. Here, the water is released for pasteurizing products in several decks and the temperature of the water in several decks is taken into consideration. The temperature of the water can here be calculated by model calculations or else be measured.

Furthermore, for a method for controlling the velocities of the superimposed decks, it is provided to take into consideration the water temperature in at least one of the decks located below the upper deck. Hereby, the method for controlling individual velocities of superimposed decks can be used to counteract the temperature difference of the spray water on the superimposed decks, when the heat transfer into the products is taken into consideration, such as to minimize the difference of the control value, e.g. PUs.

The pasteurization tunnel is characterized in that the heat transfer into the products is taken into consideration for the control of the water temperature and/or the individual velocities of the superimposed decks.

Another pasteurization tunnel where water is released for product pasteurization in several superimposed decks is characterized in that the water temperature in several decks is taken into consideration.

Another pasteurization tunnel is furthermore characterized by three superimposed decks where the water for the three decks is only released in the uppermost deck. The water is not released in the decks below, but the water of the superimposed deck is used in each deck. Due to heat transfer from the water into the products, the water temperature at the three decks in the same zones is generally different. Above the uppermost deck, water is released with a spray temperature onto the products on the uppermost deck. Depending on the temperature and the amount of products to be pasteurized (feed), a heat transfer—in the heating zones and the pasteurization zones—takes place such that the water temperature in the deck below the uppermost deck is lower than the temperature of the spray water. A heat transfer also takes place on the middle deck such that the water temperature in the lowest deck below the middle deck is lower than the water temperature on the middle deck. In order to achieve a predefined amount of PUs for the products on the three decks, among other things, the water temperatures and heat transfers into the products have to be taken into account, and the duration of time during which the products are exposed to the water in a zone is also relevant for the amount of PUs. The duration of time during which the products are exposed to the water in a zone may be controlled by the velocity by which the products are moved.

### BRIEF DESCRIPTION OF THE DRAWINGS

Advantageous embodiments of the disclosure will be illustrated with reference to the enclosed figures. In the figures:

FIG. 1 shows a schematic section of a pasteurizer with three decks;

FIG. 2 shows a schematic representation of a control loop;

FIG. 3 shows a schematic representation of another control loop;

FIG. 4 shows a schematic representation of still another control loop;

FIG. 5 shows a schematic section of a pasteurizer with three decks and nine zones with the same velocity of all three decks;

FIG. 6 shows a schematic section of a pasteurizer with three decks and nine zones with different velocities of the three decks.

### DETAILED DESCRIPTION OF THE PREFERRED EMBODIMENT

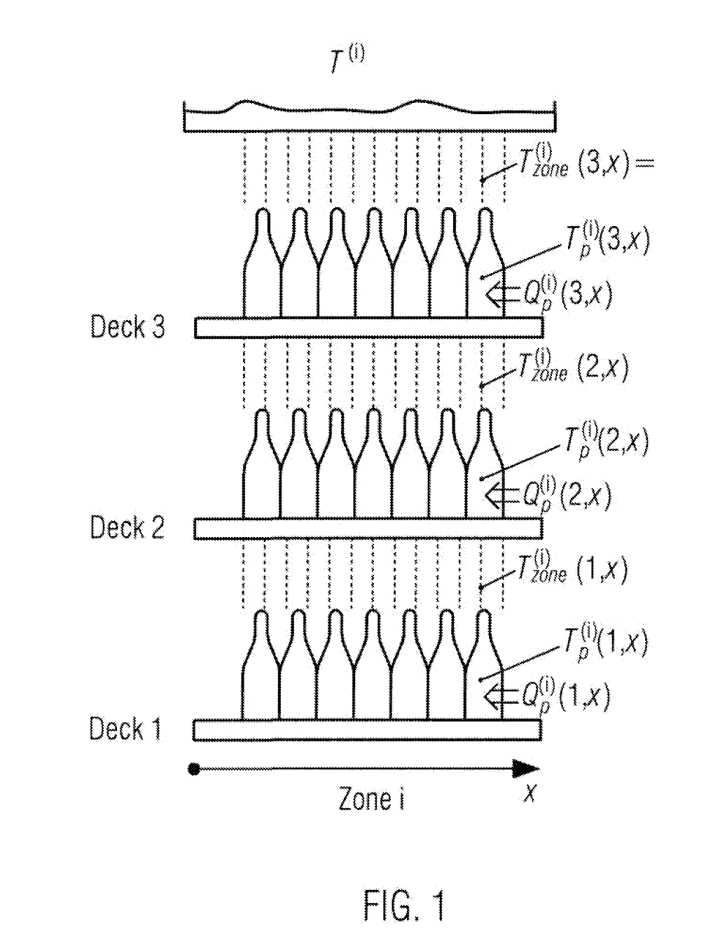

In FIG. 1, a schematic section through a pasteurization tunnel is shown. The pasteurization tunnel comprises three decks on which products (here bottles filled with beer and sealed) can be transported. The three decks are arranged one upon the other. Above the uppermost deck, there is a spraying array by means of which water can be sprayed onto the products on deck 3.

These decks are permeable to water, so that the water sprayed onto the bottles in deck 3 can flow to the bottles in deck 2, and from there to the bottles in deck 1.

In FIG. 1, a zone i is shown for which a certain temperature or a temperature profile is distinctive. Various zones are arranged successively, wherein the products are transported through the various zones.

The temperature of the sprayed-out water in zone i is referred to as T_{spray}⁽ⁱ⁾. T_{zone}⁽ⁱ⁾ (j, x) denotes the temperature in zone i in deck j at position x. The temperature in the uppermost deck (deck 3) is here equal to the spray temperature. The temperature of the products in deck j is denoted with T_{P}⁽ⁱ⁾ (j, x), where j is the number of the deck and x is the position in the zone i.

Due to a temperature difference between the temperature of the water and the temperature of the products, a heat transfer into the products takes place. The amount of heat passing into the products in the respective deck is referred to as Q_{P}⁽ⁱ⁾ (j, x), where j is the number of the deck and x the position of the products.

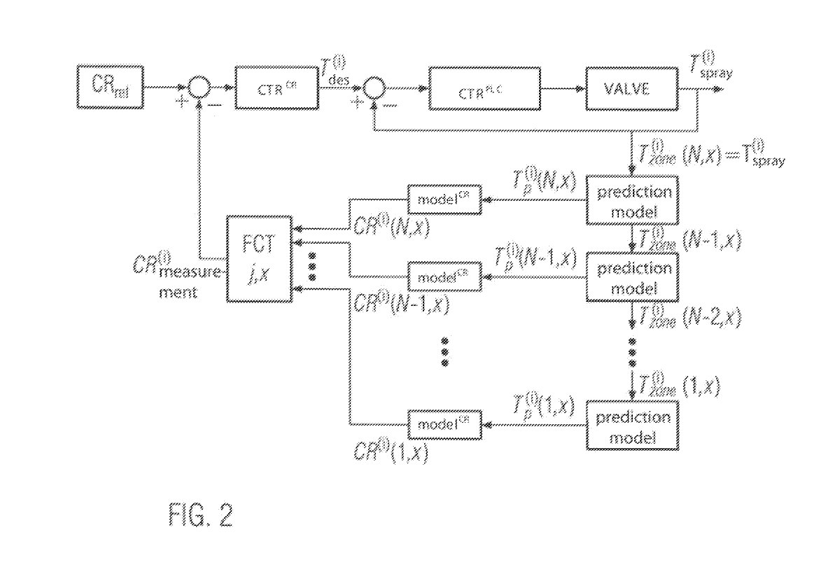

In FIG. 2, the control loop is represented schematically. CRref denotes a control target value, such as, for example, a number of PU units or a control parameter for a TAT(time above temperature)-control.

Reg^{CR} denotes a unit which calculates the desired temperature T_{des}⁽ⁱ⁾. This desired temperature is entered into a sub-control loop which adjusts the temperature of the spray water T_{spray}⁽ⁱ⁾ for zone i via a valve controlled distribution of a hot water supply.

This spray water temperature corresponds to the water temperature in the uppermost deck of the corresponding zone. A prediction model is used to predict the temperature of the products as well as the temperature of the water exiting from the respective deck. To this end, the heat transfer into the products is taken into consideration. By the heat transfer, the water for example cools down so that the temperature of the water in a lower deck is lower than the temperature of the spray water in an upper deck.

With the prediction model, the temperature T_{zone}⁽ⁱ⁾ (N-1, x) is thus calculated from the temperature T_{zone}⁽ⁱ⁾ (N, x). Here, the amount of the products to be pasteurized (feed) is also taken into consideration. The more products are located in zone i, the more the temperature of the water in a deck in the corresponding zone is changed.

A desired control value CR⁽ⁱ⁾ (j, x) is calculated in each case from the product temperature T_{P}⁽ⁱ⁾ (j, x), for deck j. To this end, a control-specific model is used which gives suited values for CR. This can be for example the number of the accepted PU units or the PU units still to be accepted, or the like.

From the plurality of CR values for the various decks, an individual CR value is determined with a function FCT. This value is referred to as CR measurement and quasi entered as actual value into the control unit for the water temperature control. In this manner, the desired control value CRref is achieved.

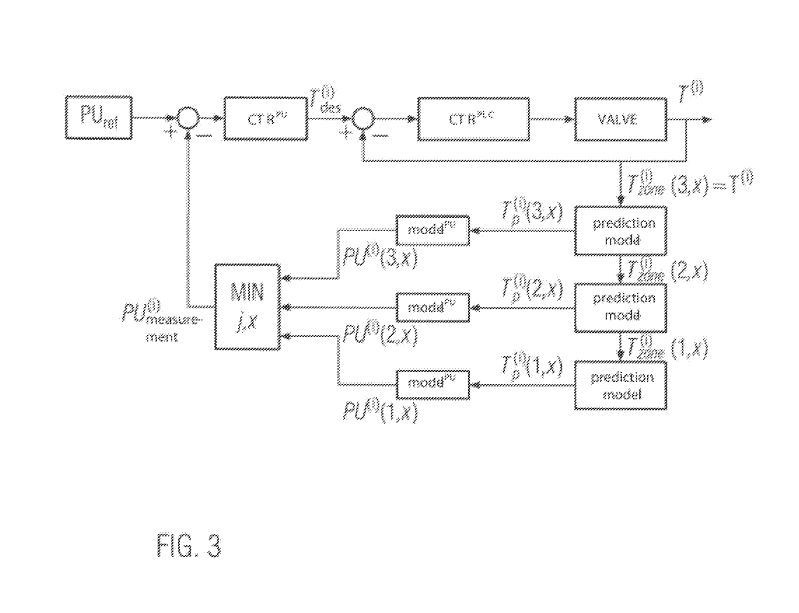

In FIG. 3, an example of a concrete control is shown where there are three decks and a PU unit control is performed.

Here, for example models model^{PU} are provided which calculate the corresponding PU units from the temperature of the products. As function FCT, a minimum function is provided which takes the smallest PU value of the calculated PU values as controlled variable PUₘₑₐₛᵤᵣₑₘₑₙₜ⁽ⁱ⁾. It is thus ensured that in all decks the desired minimum number of PU units is achieved.

As input variable for the control loop PUref, for example a number of desired PU units can be stated which are to be fed in zone (i).

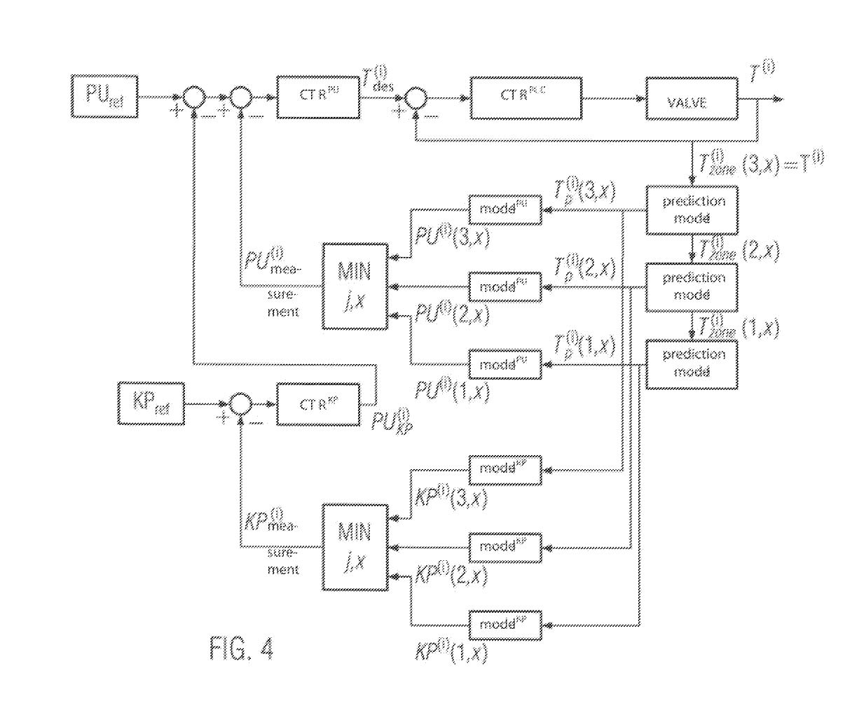

In FIG. 4, a further control loop is added which ensures that the temperature of the products in one zone is above the KP temperature (killing point temperature), where this temperature denotes the temperature as from which sterilization occurs. It is possible that sufficient PU units are also fed at low temperatures, however without sufficient sterilization being performed. To avoid this, such a control loop with several control criteria is advantageous.

Apart from the observation of a minimum temperature, a maximum temperature can also be taken into consideration for the products if the products are very temperature-sensitive.

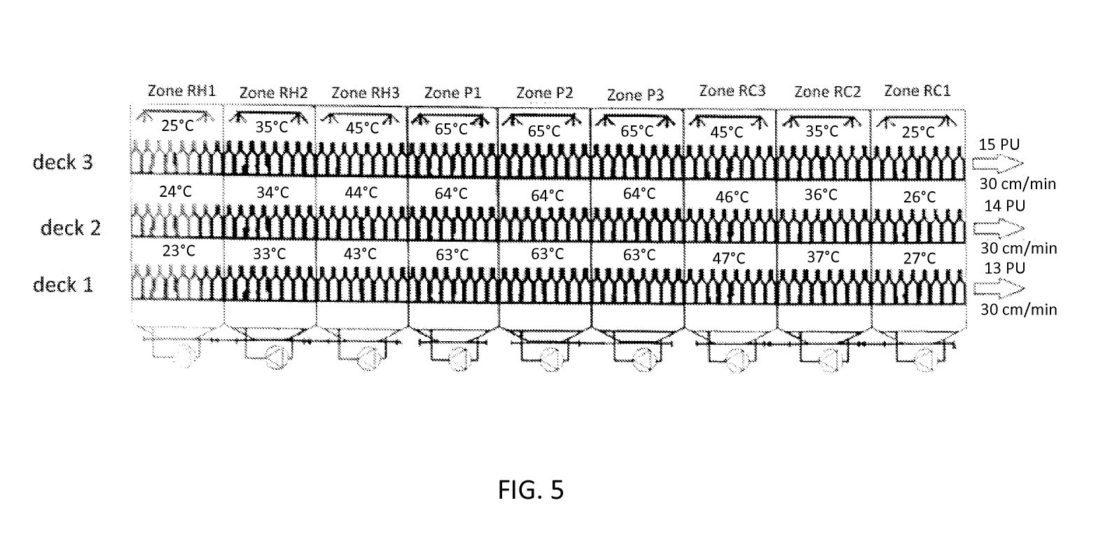

FIG. 5 shows a schematic section of a pasteurizer with three decks and nine zones, wherein three zones are heating zones RH1, RH2, RH3, three zones are pasteurization zones P1, P2, P3, and three zones are cooling zones RC3, RC2, RC1. For the different zones and the various decks, the temperature of the spray water (water released above deck 3) and the water temperatures of deck 2 and deck 1 are exemplarily given in FIG. 5; the given temperature value of a deck N and zone i may be understood as an average value of all the temperature valves T_{zone}⁽ⁱ⁾ (N,x) along the positions x in one zone i of a given deck N.

In the heating zones RH1, RH2, RH3 and in the pasteurization zones P1, P2, P3, the spray water temperature on deck 3 is higher than the water temperature on deck 2, and the water temperature on deck 2 is higher than the water temperature on deck 1 as a heat transfer takes place between the warmer water to the comparably cooler products. For example, in the heating zone RH3 the temperature of the spray water on deck 3 is 45° C., the water temperature on deck 2 is 44° C., and the water temperature on deck 1 is 43° C. In the cooling zones RC3, RC2, RC1, the temperature of the spray water is lower on deck 3 than the water temperature on deck 2, and the water temperature on deck 2 is lower than the water temperature on deck 1 as a heat transfer takes place between the cooler water to the comparably warmer products. For example, in the cooling zone RC1 the temperature of the spray water on deck 3 is 25° C., the water temperature on deck 2 is 26° C., and the water temperature on deck 1 is 27° C.

In the example shown in FIG. 5, the three decks all move with the same velocity here 30 cm/min. In this case after passing through the pasteurization tunnel, the products of deck 3 have 15 PUs, the products of deck 2 have 14 PUs, and the products of deck 1 have 13 PUs. Therefore, when 15 PUs is the desired amount of pasteurization units that is required for the product then the products on deck 2 and deck 1 do not have enough pasteurization units. In order to achieve a higher amount of pasteurization units on the lower decks, deck 2 and deck 1, the products may be transported with a lower velocity compared to the products on deck 3 such that the products on deck 2 and deck 1 stay longer in the different zones than the products on deck 3.

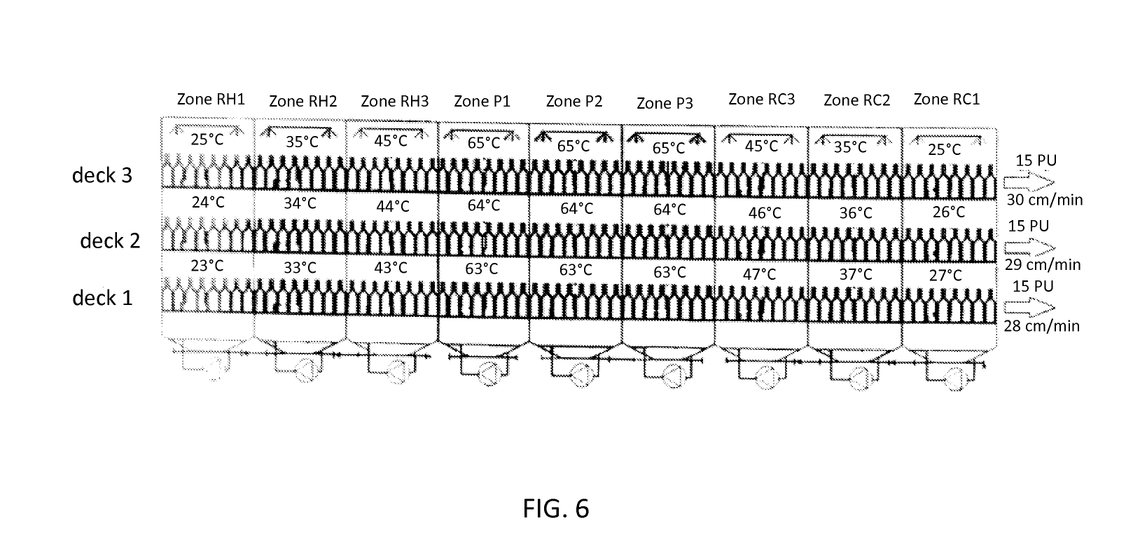

FIG. 6 shows a schematic section of the pasteurizer with the three decks and the nine zones, wherein the products on the three decks, deck 3, deck 2, deck 1, are transported with different velocities. For example, the products on deck 3 are transported with 30 cm/min as with the velocity the desired amount of 15 PUs is achieved. the products on deck 2 are transported with 29 cm/min and the products on deck 1 are transported with 28 cm/min, and thus the products on these two decks also have the desired amount of 15 PUs.

As already explained above, by using the prediction model, it is possible to predict the temperature of the products as well as the temperature of the water exiting from the respective deck. Without an adaptation of the velocities of the various decks a sufficient pasteurization can be calculated and controlled with the control-specific model such that also the products on the lowest deck, deck 1, have enough PUs as the water temperatures vary in the various decks due to heating and cooling processes and the related heat transfer. However, when the controlling is such that the products on the lowest deck, deck 1 have enough PUs then the products on the uppermost deck, deck 3, will have too much PUs. By adapting the velocities of the various decks, an equal pasteurization of the products on the various decks can be achieved.

For example, with the prediction model, the water temperature T_{zone}⁽ⁱ⁾ (N-1, x) on deck N-1 in zone i at position x may thus be calculated from the water temperature T_{zone}⁽ⁱ⁾ (N, x) on deck N in zone i at position x. The amount of the products to be pasteurized (feed) may also be taken into consideration as well as a temperature of the products. Before beginning the pasteurization process, the products may have a predefined temperature, and during the pasteurization process the temperature of the products will be predicted by taking into account the heat transfer into the products. In order to calculate the heat transfer and the achieved PUs the duration of time during which the products on a deck are exposed to the water in a zone i at a position x has to be taken into account. With the model model^{PU}, for example, a minimal amount of PU for a predefined velocity may be calculated. Thus, for finding the optimal control parameters for the pasteurization process, the prediction model and the model, model^{PU}, may be used for predicting and calculating the control parameters while also several control criteria may be taken into account, such that it is not possible, for example, to achieve sufficient PUs at too low temperatures without acquiring sufficient sterilization of the products.

What is claimed is:

1. Method for controlling water temperature of water released for product pasteurization, comprising:
releasing a volume of water having a water temperature suitable to pasteurize a product, and
controlling the water temperature, utilizing the rate of heat transfer into the products.

2. Method according to claim 1, further comprising calculating the rate of heat transfer into the products, utilizing the product temperature and water temperature of the corresponding products.

3. Method according to claim 1, further comprising determining the rate of heat transfer, utilizing the loading with products.

4. Method according to claim 1, further comprising using the water released for product pasteurization in at least two, superimposed decks, and determining the water temperature of the water in at least one of the decks below the uppermost deck utilizing the rate of heat transfer in at least one of the decks.

5. Method according to claim 1, and calculating product temperature of the products from the heat transfer into the products.

6. Method according to claim 5, further comprising for each deck calculating a desired control value for the water temperature control from the product temperature of the products in superimposed decks, and determining an individual control value from the desired control values.

7. Method according to claim 6, further comprising, for each deck, calculating a desired transport velocity of the products.

8. Method according to claim 7, further comprising, for calculating the desired transport velocity of the products, taking into account the water temperature of the released water and loading with products on each deck.

9. Method according to claim 1, further comprising providing for observation of at least two control loops for controlling the water temperature.

10. Method according to claim 9, further comprising with one of the control loops observing one of a minimum temperature, a maximum temperature, and both a minimum and maximum temperatures.

11. Method according to claim 1, further comprising performing the control of the water temperature separately in several zones arranged in series.

12. Pasteurization tunnel with a control for controlling the temperature of water released for product pasteurization, comprising:
means for utilizing the heat transfer into the products for the adjustment of the water temperature.

13. Pasteurization tunnel according to claim 12, further comprising several superimposed decks and means for controlling the water temperature, wherein the water temperature in at least one deck located below the upper deck is utilized.

14. Pasteurization tunnel according to claim 13 comprising at least two superimposed decks, wherein the water for the at least two decks being released to the products in the uppermost deck.

15. The pasteurization tunnel according to claim 14, further comprising means for determining the water temperature at a lower deck for controlling the temperature of the water released at the uppermost deck.

16. Pasteurization tunnel according to claim 12, further comprising means for controlling a transport velocity of the products in each of the several superimposed decks.
